(19) United States
(12) Patent Application Publication
(10) Pub. No.: US 2006/0271517 A1
(43) Pub. Date: Nov. 30, 2006

(54) User-driven calibration for location system

(76) Inventor: James D. Deloach JR., Los Altos, CA (US)

Correspondence Address: QUALCOMM INCORPORATED, 5775 MOREHOUSE DR., SAN DIEGO, CA, 92121, US

(21) Appl. No.: 11/137,922

(22) Filed: May 25, 2005

(51) Int. Cl. G06F 17/30

(52) U.S. Cl. 707/3

(57) ABSTRACT

A method, system, and computer-readable medium bearing instructions for calibrating a location system are described. The method includes receiving connection information regarding the connection of a device to a network and querying a user to provide input regarding the physical location of the device. User input is received regarding the physical location of the device connected to the network and the connection information and user input are stored.

### FIELD OF THE INVENTION

A system and method of calibrating a location system using user input.

### BACKGROUND

Recently, there has been a proliferation of networking opportunities for users of processor-based devices. For example, wireless network access points are available in numerous locations to which users can connect processor-based devices to obtain network connectivity. Additionally, wired network access points have become commonplace in many locations, e.g., hotels, conference centers, and similar locations, in addition to wireless capabilities which may be offered. These wireless and wired network access points allow two or more processor-based devices communicate with each other over the networks, either wired or wireless, connecting the devices.

Based on the infrastructure involved, wired network access points are more fixed in location in comparison with wireless network access clients. Wireless network access points, having lower physical emplacement requirements, i.e., dedicated cabling, etc., and being easier to rearrange or redistribute by taking advantage of wired network access points, are much easier and much more prone to relocation to different locations.

Due to the vastly distributed nature of the network access points, both wired and wireless, and the appearance and disappearance of individual access points, there is no master listing of the physical location of each access point. Additionally, due to the relatively transient nature of some network access points, it is difficult to maintain an up-to-date listing of network access point locations.

There is no easy, low-cost method for determining and updating the location of network access points according to previous approaches. In order to access wired network access points, a user needs to connect to the access point in order to report back location and connection information. In some cases, wired network access points may report their physical location over a network connection; however, this information may not be correct or up-to-date and further, it may contain only a geocoded latitude and longitude-based location information. Latitude and longitude information is less useful in many instances for users who typically do not remember lat/long locations and instead rely on street addresses and relative addresses, e.g., “two blocks from the Police Station on Main” or “1 mile North of the intersection of I-5 and I-15.”

A current approach for determining the location of wireless network access points is called “wardriving.” Wardriving is a process whereby a user with a wireless processor-based device drives around an area and discovers wireless network access points and records latitude and longitude locations of the access points. This process is extremely time consuming and requires additional time and effort to set up and maintain. Additionally, these approaches do not include a capability to automatically update or “self-learn” changes to access point locations. Further, questions remain regarding the legality of wardriving and further still, these approaches may not include information on limited access and/or non-broadcast networks to which a user wardriving may be unable to connect.

### SUMMARY

Embodiments provide a system, method, and computer-readable medium bearing instructions for calibrating a location system for network access points using user input.

A method embodiment includes calibrating a location system, including receiving connection information regarding the connection of a device to a network and querying a user to provide input regarding the physical location of the device. User input is received regarding the physical location of the device connected to the network and the connection information and user input is stored.

Another method embodiment includes calibrating a location system using user input, including receiving connection information regarding connection of a device to a network and transmitting the connection information to a second device. A user of the device is queried for user input regarding a physical location of the device and the user input regarding the physical location of the device is received. The received user input is transmitted to a second device.

An apparatus embodiment of a location system calibrated based on user input includes a processor and a memory connected to the processor. The memory stores instructions which, when executed by the processor, cause the processor to transmit a request for user input to a device connected to a network, responsive to receipt of connection information from the device, and store connection information and user input received from the device.

A system embodiment for providing user input to calibrate a location system includes a processor and a memory connected to the processor. The memory stores instructions which, when executed by the processor, cause the processor to query a user for user input regarding the physical location of a first device connected to a network, in response to a request from a second device having received connection information from the first device. The processor transmits user input received from the user to the second device.

Another system embodiment for calibrating a location system based on user input includes receiving means, transmitting means, and storing means. The receiving means receives connection information regarding the connection of a device to a network and user input regarding the physical location of the device connected to the network. The transmitting means transmits a request to the device to query the user for the user input. The storing means stores the received connection information and user input received by the receiving means.

Still other advantages will become readily apparent to those skilled in the art from the following detailed description, wherein the preferred embodiments are shown and described, simply by way of illustration of the best mode contemplated. As will be realized, other and different embodiments are possible, and several details are capable of modifications in various obvious respects, all without departing from the scope.

### DESCRIPTION OF THE DRAWINGS

Embodiments are illustrated by way of example, and not by limitation, in the figures of the accompanying drawings, wherein elements having the same reference numeral designations represent like elements throughout and wherein:

FIG. 1 is a high level system diagram in which an embodiment may be used;

FIG. 2 is a high level process flow diagram of client software functionality in accord with an embodiment;

FIG. 3 is a block diagram of computer system on which the process flow of FIG. 2 may be executed;

FIG. 4 is a high level process flow diagram of server software functionality in accord with an embodiment;

FIG. 5 is a block diagram of a computer system on which the process flow of FIG. 4 may be executed;

FIG. 6 is a first interaction diagram of an initial connection and update embodiment;

FIG. 7 is a second interaction diagram of a server-initiated update embodiment;

FIG. 8 is a third interaction diagram of a query embodiment; and

FIG. 9 is a fourth interaction diagram of a two client connection embodiment.

### DETAILED DESCRIPTION

In contrast with the above-described approaches, the mechanism of the present invention provides a location system for network access points which is calibrated by user input.

System Overview

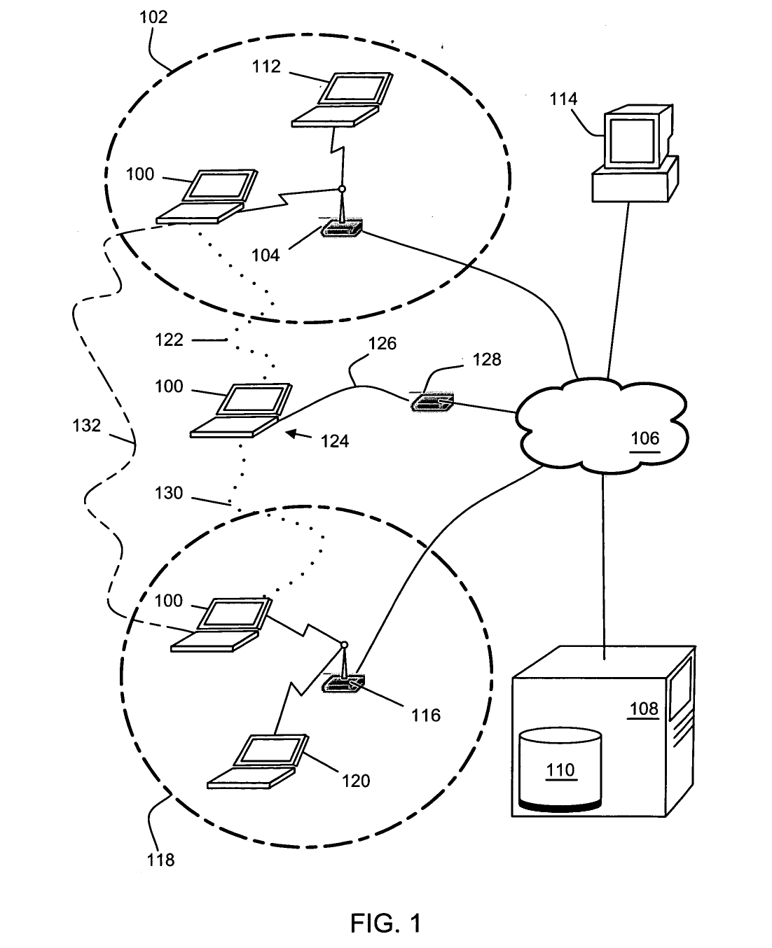

In accordance with one embodiment, FIG. 1 depicts a mobile computer system (MCS) 100, e.g., a laptop, handtop, palmtop, mobile telephone, or other transportable computer system, located in a wireless network area 102 and connected wirelessly to a wireless access point (WAP) 104 generating the wireless network area. WAP 104, in turn, is connected via a wired connection to a network 106 and thereby to a server 108. WAP 104 broadcasts a signal to and receives a signal from wireless devices located within wireless network area 102. Mobile computer system 100 wirelessly connects to WAP 104 and receives information from the WAP regarding the connection of mobile computer system 100 to WAP 104. A user of mobile computer system 100 inputs information regarding the physical location of the mobile computer system and the mobile computer system provides the received user input, i.e., location information, and connection information to server 108 via the wireless connection to WAP 104 and thereon via network 106. Server 108 stores the received user input and connection information to a data store 110 within the server. In this manner, user input, i.e., location information, regarding mobile computer system 100 is obtained and stored in data store 110, as well as, other information regarding WAP 104.

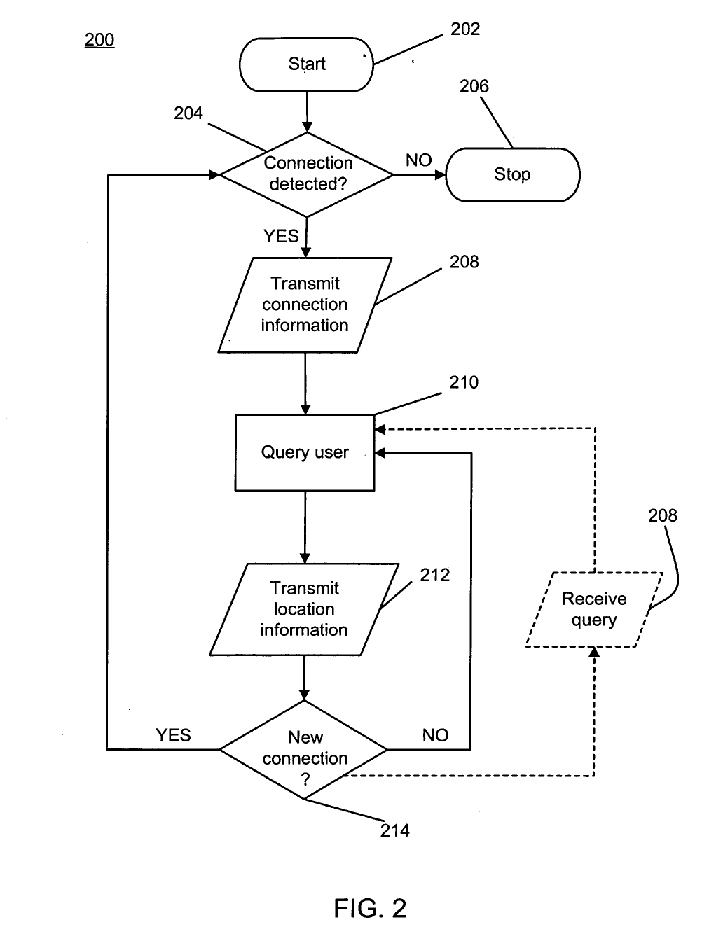

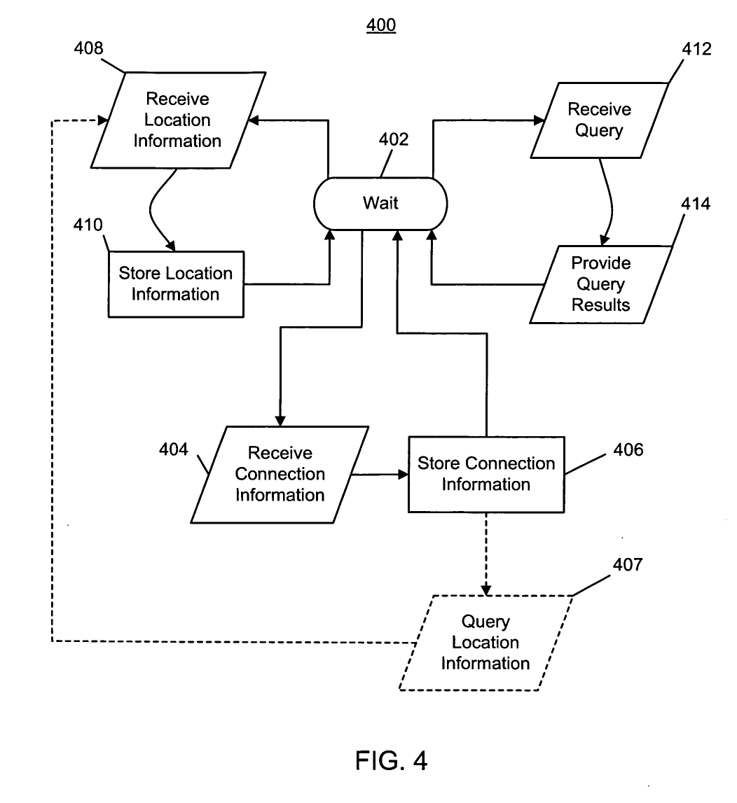

In the above-described embodiment, MCS 100 executes client software (described below in connection with FIG. 2) for receiving location and connection information and transmitting the information to server 108. Server 108 executes server software (described below in connection with FIG. 4) for receiving and storing the location and connection information from MCS 100. In alternate embodiments, server 108 includes server software for querying client software on MCS 100 to obtain and update location and connection information previously provided to server 108. In one embodiment, server 108 determines the timing and content of the query provided to the user via MCS 100. For example, server 108 determines whether to present a request for location information to a user in the form of an entry field, e.g., for receiving a text entry, in the form of a list of selections, e.g., previously-provided or preset locations, or not to request location information from the user at a particular time and/or location, e.g., to avoid user aggravation. Further, server 108 may present a map or other location presentation mechanism to the user via MCS 100 and request the user to confirm or refine the presented location. In accordance with the foregoing embodiment, server 108 may utilize human interaction and psychological factors in determining the timing, frequency, and content of querying the user of MCS 100 to provide location information.

In a further embodiment, server 108 includes server software for responding to information queries received from network-connected processor-based devices, e.g., MCS 100, a second MCS 112, desktop computer system 114 (described below), or other devices. For example, second MCS 112 may be physically located in wireless network area 102 being wirelessly connected to WAP 104, and a desktop computer system 114 may be connected by wire to network 106.

In one embodiment, a second user located at desktop computer system 114 manipulates the computer system to query server 108 and obtain information stored in data store 110 for display using the desktop computer system. For example, the second user manipulates desktop computer 114 to cause the generation and transmission to server 108 of a query regarding location information stored in data store 110 regarding the physical location of MCS 100. In response to receipt of the query, server 108 retrieves the location information from data store 110 and transmits the location information to desktop computer system 114 via network 106 for display to the user. For example, server 108 retrieves the requested location information, and transmits a formatted web page to desktop computer system 114 for viewing by the user.

Further still, FIG. 1 depicts MCS 100 at different times located at different locations and respectively connected to network 106 via a wired connection 128 and a second wireless connection 116 within wireless network area 118. More specifically, after the user relocates (depicted by dashed line 122) MCS 100 from a first location within wireless network area 102 to a second location generally indicated by reference numeral 124, the user connects the MCS to a wired connection 126 provided by a wired network access point (WNAP) 128, e.g., a dial-up, broadband, or other wired network connection capability. Wired connection 126 provides connectivity to server 108 via the connection of WNAP 128 to network 106.

After MCS 100 connects to WNAP 128, the MCS transmits connection information and location information reflecting the new connection and location to server 108 for storage in data store 110. The updated connection and location information reflects the new location of MCS 100, as well as, provides additional information regarding WNAP 128 in addition to the previously provided WAP 104 information. User-provided information, e.g., at least the user-supplied physical location input (as described below), aids in determining both the location of MCS 100 (and the user of the MCS) and access points, such as WAP 104 and WNAP 128.

In accordance with an above-described embodiment, server 108 determines the timing and content of the query presented to the user via MCS 100. For example, if MCS 100 has previously connected to WNAP 128, server 108 may be able to perform a lookup based solely on provided connection information and not require location information from the user. In an other embodiment, server 108 may request confirmation of previously provided location information.

At some point in time, the user relocates (depicted by dashed line 130) MCS 100 from second location 124 to a third location within wireless network area 118. For example, the user may relocate MCS 100 to a second WAP 116 which is connected via a wired connection to network 106. Second WAP 116 generates a wireless network area 118, similar to wireless network area 102, within which may be located and connected thereto a third MCS 120. MCS 100 establishes a second wireless connection to WAP 116 and thereby to server 108 via the connection of WAP 116 to network 106.

After MCS 100 connects to WAP 116, the MCS transmits connection information and location information reflecting the new connection and location to server 108 for storage in data store 110. The updated connection and location information reflects the new location of MCS 100, as well as, provides information regarding WAP 116 in addition to the previously provided WAP 104 and WNAP 128 information.

Similar to the above-described other embodiment, server 108, in an other embodiment, determines the timing and content of the query presented to the user via MCS 100.

In this manner, as MCS 100 relocates to different locations and reports connection and location information to server 108, access point information is gathered and stored in data store 110. Consequently, location and connection information regarding MCS 100 is also gathered and stored in data store 110. Further, as MCS 100 returns to previously visited locations, e.g., returns to wireless network area 102 via dash-double-dot line 132, connection and location information for the previously visited access points such as WAP 104 are compared with stored connection and location information in data store 110 and updates are performed. Additionally, as described below in further detail, subsequent visits to locations provide additional opportunity to refine existing location information. Further still, subsequent visits to locations previously visited by another user of a different MCS, e.g., MCS 112, may be used and/or refined through the interaction of the user of MCS 100 and server 108. That is, server 108 uses previously provided location information from an earlier user to visit a location in order to query a later user visiting the same location.

The terms “mobile computer system” as used herein are intended to include computing devices which are transportable by users from one physical location to another. Examples of such devices include a laptop, a personal digital assistant, a handtop, a palmtop, mobile telephone, or other transportable computing device capable of accessing a wired or wireless network.

The terms “wireless network” and “wireless access point” as used herein are intended to include wireless forms of communication between at least two devices. Examples of such devices include cellular or PCS, satellite, Bluetooth, infrared, WiFi, and other similar types of wireless communication mechanisms.

Network 106 is intended to include any type of communication connection between the least two devices. Examples of network 106 include a wide area network (WAN), a local area network (LAN), a point-to-point network, an intranet, a collection of networks generally referred to as the Internet, and other similar networks. Existing and future network types are suitable for use with the described embodiments.

With respect to the architecture depicted in FIG. 1, MCS 100, second MCS 112, third MCS 120, and desktop computer system 114 may be viewed as clients of server 108. In an alternate embodiment, one of the clients 100, 112, 120, 114 replaces server 108 in FIG. 1 and assumes a server role.

Client Software

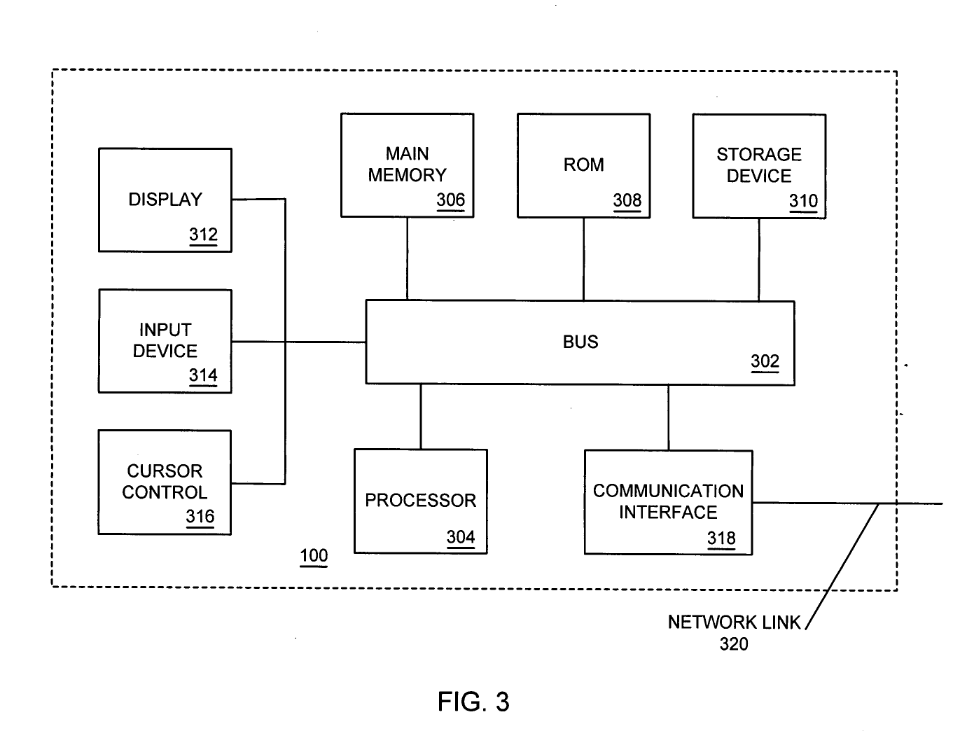

FIG. 2 depicts a high level process flow diagram of a client portion 200 of an embodiment for execution on a computer system, e.g. MCS 100. MCS 100 is described in more detail below with respect to FIG. 3. The process flow starts at step 202 wherein processor 304 (FIG. 3) executes sequences of instructions representing client portion 200 and process flow proceeds to step 204. In Step 204, processor 304, executing instructions and communicating with communication interface 318 (FIG. 3), determines whether a connection has been established with a network, e.g., a wireless or wired connection to a network such as the wireless connection of mobile computer system 100 to WAP 104 of FIG. 1. If a network connection has not been established, the process flow proceeds to step 206 and ends.

On the other hand, if a network connection has been established, processor 304 executes instructions to determine connection information. The terms “connection information” as used herein are intended to include any information available concerning the connection of MCS 100 to a network such as WAP 104. Examples of connection information include a user identity, an access point identity, e.g., a MAC address, a timestamp, e.g., a current time, a connection time, and a disconnection time from the previous connection, and if available a network type, e.g., wireless or wired. Further information may be detected based on the connection type, e.g., signal related parameters for wireless networks, such as signal strength, signal coverage, signal-to-noise ratio, and error rate parameters. Additional exemplary information includes system identifier, network identifier, and base identifier for code division multiple access (CDMA) systems and mobile country code, mobile network code, location area identifier, and cell identifier for global system for mobile communications (GSM), and other similar identifying information for other systems.

After detection of connection information, the process flow proceeds to step 208 and processor 304 transmits the connection information to server 108 via network 106. In one embodiment, MCS 100 connects to and authenticates with server 108 prior to transmitting connection information to the server, e.g., by transmission of a user name and/or password.

The flow of control proceeds to step 210 and processor 304 drives display 312 (FIG. 3) to display a query to the user of MCS 100 to input physical location information regarding the MCS. In one embodiment as described above, server 108 determines the timing and content of the location information query presented to the user of MCS 100.

The terms “physical location information” as used herein are intended to include any information provided by the user describing or defining the physical location at which MCS 100 is located. Examples of such information include an address or part of an address such as a street name, city, state, building or house number, and other address types, a relative location such as a position with respect to a landmark for an area. For example, a user may supply an input such as “Sunnyvale, Calif.,” “3231 Hollenbeck, Sunnyvale, Calif.,” “the Starbucks in Sunnyvale.”

In one embodiment, processor 304 provides a list of preset physical locations from which the user selects for input. The list of preset physical locations may be predetermined from location information stored in memory of MCS 100 and/or may include previously input physical locations. In another embodiment, processor 304 uses the connection information obtained in step 208 in combination with stored connection information and location information from previous connections in order to match the current connection with a previous connection and thereby provide the previous location information entered by the user as an initial default value for input by the user. In a further embodiment, the preset physical locations may be obtained from server 108.

After receipt of user input, processor 304 proceeds to step 212 and transmits the location information to server 108 via network 106 and communication interface 318. The flow of control proceeds to step 214 wherein processor 304 determines whether a new network connection is established. The step 214 determination may be performed on a periodic basis or as a result of receipt of a message from server 108 instructing processor 304 to perform the step 214 determination.

If the result of step 214 is positive the flow control returns to step 204 and the process proceeds as described above. Following this flow results in new or updated connection and location information being collected and transmitted by processor 304 to server 108.

If the result of step 214 is negative, the flow control proceeds to step 210 and proceeds as described above. Following this flow results in confirmation or update of location information. In one exemplary embodiment, the user is iteratively queried to refine the provided location information. In this manner, broad, generic or possibly conflicting location information entries may be narrowed, differentiated, and/or disambiguated from each other.

In one alternate embodiment, if the result of step 214 is negative, the flow of control proceeds to step 216 (dashed line) and the MCS waits to receive a query for the user from server 108. Server 108, as described above, determines the timing and content of the query and upon receipt of the query by MCS 100, the flow of control proceeds to step 210 and the user is presented with the received query.

Client Hardware

FIG. 3 is a high level block diagram of a computer system, such as MCS 100, upon which client portion 200 may be implemented.

MCS 100 includes a bus 302 or other communication mechanism for communicating information, and a processor 304 coupled with the bus 302 for processing information. MCS 100 also includes a main memory 306, such as a random access memory (RAM) or other dynamic storage device, coupled to the bus 302 for storing location information and connection information, and instructions to be executed by processor 304. Main memory 306 also may be used for storing temporary variables or other intermediate information during execution of instructions to be executed by processor 304. MCS 100 further includes a read only memory (ROM) 308 or other static storage device coupled to the bus 302 for storing static information and instructions for the processor 304. A storage device 310, such as a magnetic disk or optical disk, is provided and coupled to the bus 302 for storing location information, connection information, and instructions.

MCS 100 may be coupled via the bus 302 to a display 312, such as an integrated flat panel display, for displaying information to and prompting for information from the user. An input device 314, including alphanumeric and function keys, is coupled to the bus 302 for communicating information and command selections to the processor 304. Another type of user input device is cursor control 316, such as a mouse, a trackball, or cursor direction keys for communicating direction information and command selections to processor 304 and for controlling cursor movement on the display 312. This input device typically has two degrees of freedom in two axes, a first axis (e.g., x) and a second axis (e.g., y) allowing the device to specify positions in a plane.

An embodiment is related to the use of MCS 100, such as the illustrated system of FIG. 3, to enable user-driven calibration for a location system for network access points. According to one embodiment, connection information and location information are provided to MCS 100 in response to processor 304 executing sequences of instructions contained in main memory 306 in response to input received via input device 314, cursor control 316, or communication interface 318. Such instructions may be read into main memory 306 from another computer-readable medium, such as storage device 310.

However, the computer-readable medium is not limited to devices such as storage device 310. For example, the computer-readable medium may include a floppy disk, a flexible disk, hard disk, magnetic tape, or any other magnetic medium, a CD-ROM, any other optical medium, punch cards, paper tape, any other physical medium with patterns of holes, a random access memory (RAM), a programmable read only memory (PROM), an electrically programmable read-only memory (EPROM), a FLASH-EPROM, any other memory chip or cartridge, a carrier wave embodied in an electrical, electromagnetic, infrared, or optical signal, or any other medium from which a computer can read. Execution of the sequences of instructions contained in the main memory 306 causes the processor 304 to perform the process steps described below. In alternative embodiments, hard-wired circuitry may be used in place of or in combination with computer software instructions to implement the invention. Thus, embodiments of the invention are not limited to any specific combination of hardware circuitry and software.

MCS 100 also includes a communication interface 318 coupled to the bus 302. Communication interface 318 provides two-way data communication. For example, communication interface 318 may be an integrated services digital network (ISDN) card, a digital subscriber line (DSL) card, or a modem to provide a data communication connection to a corresponding type of telephone line. As another example, communication interface 318 may be a local area network (LAN) card to provide a data communication connection to a compatible LAN. As described above, wireless links may also be implemented, e.g., IEEE 802 standard wireless connections, and other wireless connections. In any such implementation, communication interface 318 sends and receives electrical, electromagnetic or optical signals which carry digital data streams representing various types of information. Of particular note, the communications through interface 318 may permit transmission or receipt of connection information and location information. For example, two or more MCS 100 may be networked together in a conventional manner with each using the communication interface 318.

Network link 320 typically provides data communication through one or more networks to other data devices. For example, network link 320 may provide a connection through network 106 to a server 108 or to another device, e.g., desktop computer system 114. The signals through the various networks and the signals on network link 320 and through communication interface 318, which carry the digital data to and from MCS 100, are exemplary forms of carrier waves transporting the information.

MCS 100 can send messages and receive data, including program code, through the network(s), network link 320 and communication interface 318. In the Internet example, a server 108 might transmit a requested code for an application program through Internet, e.g., network 106, network link 320, and communication interface 318. In accordance with one embodiment, one such downloaded application provides for user-driven calibration for a location system for network access points.

The received code may be executed by processor 304 as it is received, and/or stored in storage device 310, or other non-volatile storage for later execution. In this manner, MCS 100 may obtain application code in the form of a carrier wave.

Server Software

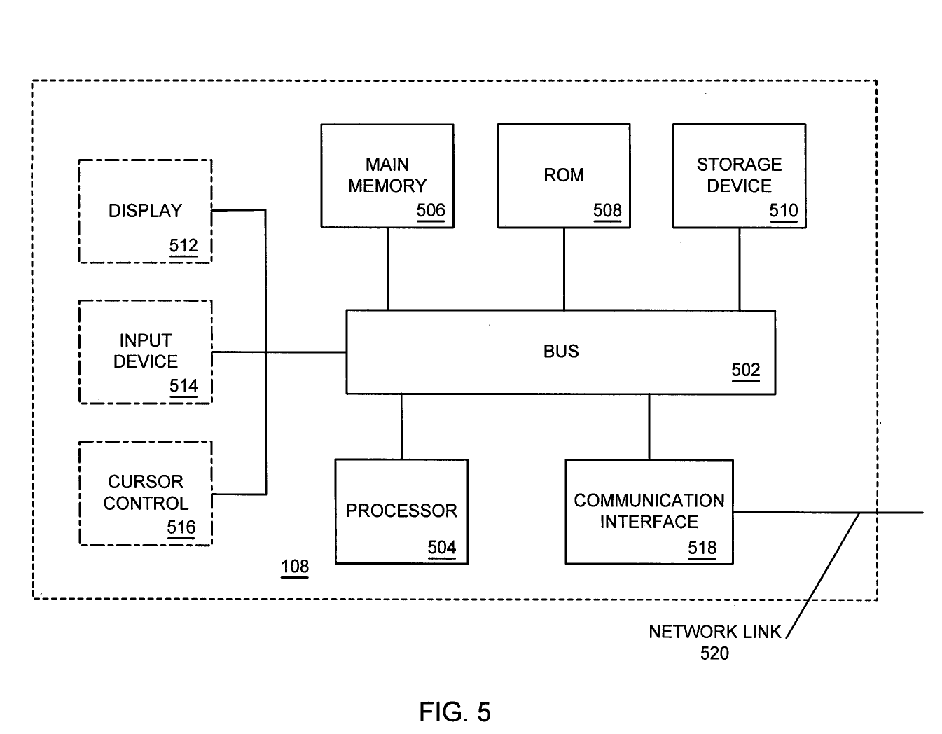

FIG. 4 depicts a high-level process flow diagram of a server portion 400 of an embodiment for execution on a computer system, e.g., server 108. Server 108 is described in more detail below with respect to FIG. 5. By executing instructions stored in memory, processor 504 (FIG. 5) performs the process steps depicted with respect to server portion 400 in FIG. 4. Server portion 400 is also referred to as the location manager software, or alternatively location manager. Processor 500 executing server portion 400 waits for input at step 402. Input is typically received via communication interface 518; however, in one or more embodiments input may be received via input device 514 and/or cursor control 516. In another embodiment, server portion 400 transmits a query to MCS 100 to obtain a most recent location update, e.g., in response to a query received from desktop computer system 114.

Upon receipt of connection information from MCS 100 (as described above in connection with FIG. 2) via network 106 and communication interface 518, processor 504 proceeds to step 404 and receives the connection information. Processor 504 then proceeds to step 406 and stores the connection information in data store 110. Processor 504, following the flow of control, proceeds to step 402 wherein the executing server portion 400 awaits further input.

Upon receipt of location information from MCS 100 (as described above in connection with FIG. 2) via network 106 and communication interface 518, processor 504 proceeds to step 408 and receives the location information. Processor 504 then proceeds to step 410 and stores the location information in data store 110. The flow of control then returns to step 402 wherein the server portion 400 executed by the processor awaits further input.

Upon receipt of a query from desktop computer system 114 (as described below) via network 106 and communication interface 518, processor 504 proceeds to step 412 and receives and executes the query in connection with data store 110. Processor 504 then proceeds to step 414 and transmits the results of the query to desktop computer system 114 via communication interface 518 and network 106.

In an alternate embodiment, after server 108 stores the received connection information at step 406, processor 504 proceeds to optional step 407 (dashed line) wherein the processor determines whether to transmit via communication interface 618 a query to MCS 100 causing the mobile computer system to query the user for location information (steps 216 and 210 of FIG. 2). As described above, server 108 determines the timing and content of the query transmitted to MCS100. Upon receipt of user input location information, processor 504 proceeds to step 408 and the flow of control proceeds as described above.

Server Hardware

FIG. 5 is a block diagram illustrating an exemplary server 108 upon which an embodiment such as server portion 400 may be implemented.

Server 108 includes a bus 502 or other communication mechanism for communicating information, and a processor 504 coupled with the bus 502 for processing information. Server 108 also includes a main memory 506, such as a random access memory (RAM) or other dynamic storage device, coupled to the bus 502 for storing transaction and interaction data, and instructions to be executed by processor 504. Main memory 506 also may be used for storing temporary variables or other intermediate information during execution of instructions to be executed by processor 504. Server 108 further includes a read only memory (ROM) 508 or other static storage device coupled to the bus 502 for storing static information and instructions for the processor 504. A storage device 510, such as a magnetic disk or optical disk, is provided and coupled to the bus 502 for storing transaction and interaction data, inventory data, orders data, and instructions. In one embodiment, data store 110 is a part of storage device 510. In another embodiment, data store 110 is an additional storage device in addition to storage device 510.

Server 108 may be coupled via the bus 502 to an optional display 512 (dot-dash line), such as a cathode ray tube (CRT) or a flat panel display, for displaying information to and prompting for information from the user. An optional input device 514 (dot-dash line), including alphanumeric and function keys, may be coupled to the bus 502 for communicating information and command selections to the processor 504. Another type of optional user input device is cursor control 516 (dot-dash line), such as a mouse, a trackball, or cursor direction keys for communicating direction information and command selections to processor 504 and for controlling cursor movement on the display 512. This input device typically has two degrees of freedom in two axes, a first axis (e.g., x) and a second axis (e.g., y) allowing the device to specify positions in a plane.

An embodiment is related to the use of server 108, such as the illustrated system of FIG. 5, to enable user-driven calibration for a location system for network access points. According to one embodiment, connection information and location information are provided to server 108 in response to processor 504 executing sequences of instructions contained in main memory 506 in response to input received via input device 514, cursor control 516, or communication interface 518. Such instructions may be read into main memory 506 from another computer-readable medium, such as storage device 510.

However, the computer-readable medium is not limited to devices such as storage device 510. For example, the computer-readable medium may include a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave embodied in an electrical, electromagnetic, infrared, or optical signal, or any other medium from which a computer can read. Execution of the sequences of instructions contained in the main memory 506 causes the processor 504 to perform the process steps described above. In alternative embodiments, hard-wired circuitry may be used in place of or in combination with computer software instructions to implement the embodiment. Thus, embodiments are not limited to any specific combination of hardware circuitry and software.

Server 108 also includes a communication interface 518 coupled to the bus 502. Communication interface 508 provides two-way data communication. For example, communication interface 518 may be an integrated services digital network (ISDN) card, a digital subscriber line (DSL) card, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals which carry digital data streams representing various types of information. Of particular note, the communications through interface 518 may permit transmission or receipt of connection information and location information. For example, two or more computer systems 108 may be networked together in a conventional manner with each using the communication interface 518. Additionally, more than one MCS may communicate with server 108 at one time over interface 518.

Network link 520 typically provides data communication through one or more networks to other devices. For example, network link 520 may provide a connection through network 106 to MCS 100 or desktop computer system 114. Network 106 uses electrical, electromagnetic or optical signals which carry digital data streams. The signals through the various networks and the signals on network link 520 and through communication interface 518, which carry the digital data to and from server 108, are exemplary forms of carrier waves transporting the information.

Server 108 can send messages and receive data, including program code, through the network(s), network link 520 and communication interface 518. In an Internet example, server 108 might transmit a requested code for an application program through network 106, network link 520, and communication interface 518. In accordance with the invention, one such downloaded application provides for user-driven calibration for a location system for network access points.

The received code may be executed by processor 504 as it is received, and/or stored in storage device 510, or other non-volatile storage for later execution. In this manner, server 108 may obtain application code in the form of a carrier wave.

Query/Result Interaction

Desktop computer system 114, similar to MCS 100 described and depicted in FIG. 3, communicates with server 108 via network 106. Desktop computer system 114 includes a processor and memory storing instructions for execution by the processor similar to MCS 100. Executable software stored in memory enables a user of desktop computer system 114 to transmit one or more queries to server 108 regarding information stored in data store 110.

In one embodiment, executable software includes database access tools for directly querying data store 110 from desktop computer system 114 and displaying the results on an attached display to the user at the desktop computer system. In another embodiment, executable software includes a browser-type software enabling access to functionality provided by server 108, e.g., via a web-based query submission form, for the user to create and submit queries to be executed by server 108 and receive and display query results from the server on a display to the user. It will be understood by persons skilled in the art that additional query and response mechanisms are available without departing from the scope of the embodiments described herein. It is further understood that other networked devices, e.g., MCS 100, second MCS 112, and server 108 may be used in alternate embodiments to query data store 110 and provide results of the query to a user.

In one example, a user at desktop computer system 114 issues a query for the most recent location of a particular user as stored in data store 110. Server 108 receives and executes the query (step 412 of FIG. 4) on the connection and location information stored in data store 110. Then, server 108 transmits the query results to desktop computer system 114 (step 414 of FIG. 4) for display to the user. For example, the user at the desktop computer system 114 may enter the name of a user of a MCS 100 into a web-based form in a web browser and cause issuance of the query to server 108. Server 108 formats the query into a web page including the location information associated with the user, such as a map image identifying the location of the requested user with an indicator icon, as described below. Upon receiving the query result from server 108, desktop computer system 114 displays the location information, such as the map image in the web browser to the user. Additional embodiments for creating queries and displaying query results to users will be understood to persons skilled in the art. For example, based on receipt of time information from MCS 100 in conjunction with connection information and/or location information, server 108 may construct a time history of the connection locations of the MCS.

In another embodiment, in order to obtain up-to-date connection and/or location information, server 108 transmits a query to MCS 100 either in addition to or in place of querying data store 110, as described above. Upon receipt of the query from server 108, MCS 100 transmits the current connection and/or location information to the server.

### EXAMPLES

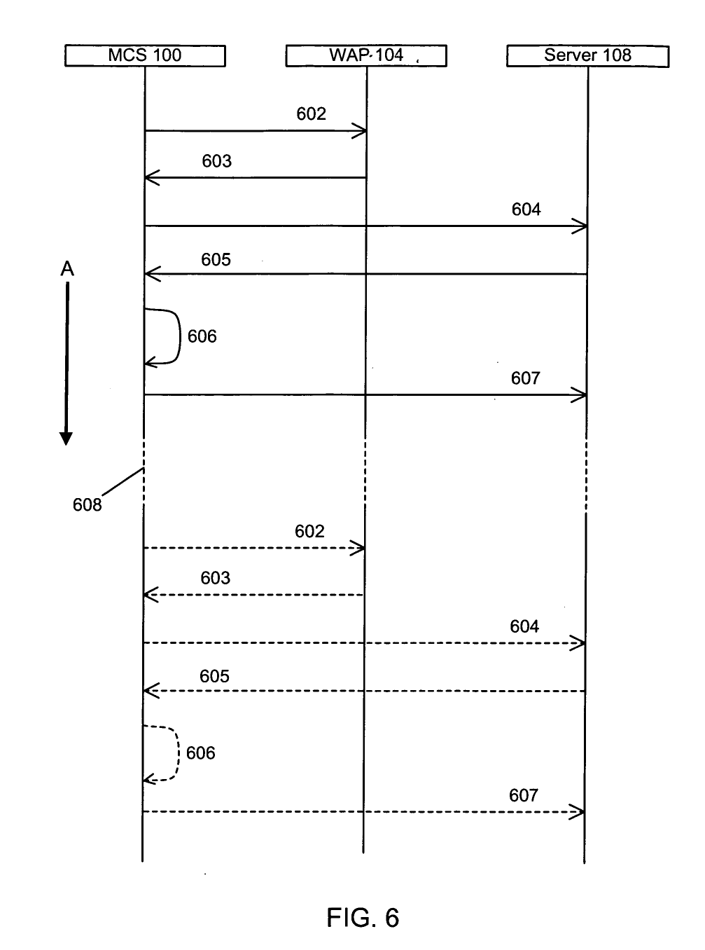

A first example of operation of an above-described embodiment is now described in conjunction with the interaction diagram of FIG. 6. FIG. 6 is a high level interaction diagram depicting the flow of requests and responses between MCS 100, WAP 104, and server 108 according to the processes described above. With respect to FIG. 6, time proceeds down the page from top to bottom as indicated by reference arrow A.

After establishing a network connection to WAP 104, MCS 100 transmits a WAP connection information request message 602 to the WAP, or in an alternate embodiment to the client hardware responsible for maintaining the connection to the WAP, requesting connection information regarding the established network connection. Exemplary types of WAP connection information requested are as described above in connection with connection information, e.g., WAP 104 MAC address, average signal-to-noise ratio, signal strength, bit error rate, and data rate related to the WAP. WAP 104 responds to request message 602 with a reply message 603 including the requested WAP connection information.

MCS 100, after receipt of the requested connection information, transmits the WAP connection information message 604 to server 108. Server 108 stores the received connection information in data store 110 for subsequent processing. Server 108 optionally transmits location information request message 605 to MCS 100 causing the MCS to request location information be input by a user of the MCS.

At processing loop 606, MCS 100 queries the user to input the requested location information as described above. For example, processor 304 drives display 312 to present a window or other user interface element requesting the user to input a text description of the physical location of WAP 104. In alternate embodiments, the user inputs the location of WAP 104 and/or MCS 100. After receiving the user input location information, MCS 100 transmits a location information message 607 to server 108.

Upon receipt of location information message 607, server 108 stores the received location information in data store 110 for subsequent processing. In one embodiment, server 108 stores the location information and connection information in a database enabling sorting, retrieval, and further analysis of the stored information. In another embodiment described previously, server 108 determines the timing and content of the query provided by MCS 100 to the user for the location information.

The flow of requests and responses depicted in FIG. 6 is performed for each connection of MCS 100 to a network enabling access to server 108. In this manner, location information and connection information regarding one or more access points and the physical location of the access points is determined.

In a further embodiment, depicted by dashed line messages 602-607, MCS 100 requests updates to the previously received location information and connection information and transmits updated information, if any, to server 108. According to one embodiment, a predetermined time period 608 elapses prior to MCS 100 requesting: (1) updated connection information via connection information request message 602 to WAP 104; and (2) updated location information via location information request message 606 to the user. Alternate embodiments in which different periods are used for requesting location information and connection information are within the present scope. Additionally, an explicit change of network connection, e.g., the user moving the MCS 100 from within wireless network area 102 to either second location 124 or wireless network area 118, causes MCS 100 to transmit messages 602-607 in another embodiment.

Further, after connection information and location information have been obtained, each information set may be updated separately, e.g., at different rates and time periods, and in differing order from that depicted in FIG. 6.

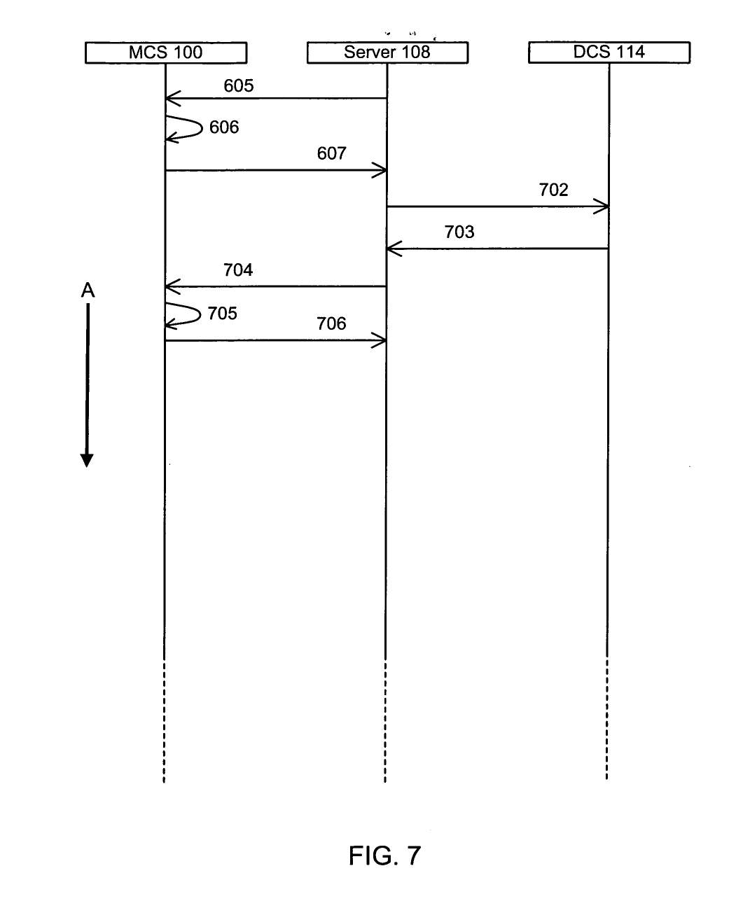

FIG. 7 is a high level interaction diagram depicting the flow of requests and responses between MCS 100, WAP 104, server 108, and an external database of locations, e.g., stored on desktop computer system (DCS) 114 according to another embodiment. Similar to FIG. 6, time proceeds down the page from top to bottom as indicated by reference arrow A.

Assuming a network connection has been established, server 108 transmits location request message 605 to MCS 100 as described above in order to obtain location information from the MCS user. Similar to FIG. 6, MCS 100 displays a query to the user requesting location information via processing loop 606 and then transmits the received user input location information to server 108 using location information message 607.

Upon receipt of location information message 607 in this embodiment, server 108 transmits location lookup message 702 to DCS 114 via network 106 and requests the DCS to perform a lookup of the user input location information provided. DCS 114 accesses additional location information stored in memory at the DCS in order to determine whether the user input location information is able to be refined, e.g., is there more than one physical location described by the user input? For example, a user input location information may include the string, “I'm at the Starbucks in Sunnyvale.” DCS 114 performing a lookup of the string determines two physical locations matching the user input: a Starbucks on Hollenbeck in Sunnyvale and a Starbucks on Mary in Sunnyvale. DCS 114 transmits a location lookup results message 703 to server 108.

In an alternate embodiment, server 108 provides a map displaying possible locations to MCS 100 which in turn queries the user to select or refine-the appropriate location. For example, the user can be presented with a map, whereupon the user can click on the appropriate point on the map to indicate his present position.

Upon receipt of the location lookup results message 703, server 108 transmits a refine location message 704 to MCS 100 in order that the user may refine the location information provided. MCS 100 prompts the user via processing loop 705, similar to processing loop 606, to refine the previously provided user input location information. After receipt of user input providing refined location information, MCS 100 transmits the refined location information to server 108 via a location information message 706. In one embodiment, location information message 706 is identical to location information message 607.

Multiple iterations of refining the user input location information are possible in alternate embodiments. In another embodiment, the functionality described above with respect to DCS 114 is performed by server 108 accessing data store 110. In a further embodiment, the functionality described above with respect to DCS 114 is performed by MCS 100 accessing either an internal data store or a network-accessible data store in order to refine the user input location information prior to submission to server 108.

In a still further embodiment, the determination regarding requesting refined location information from the user is a function of the location information stored in data store 110. For example, if server 108 determines that the provided user input location information uniquely identifies at most one location information stored in data store 110, then the server need not request refined location information from the user.

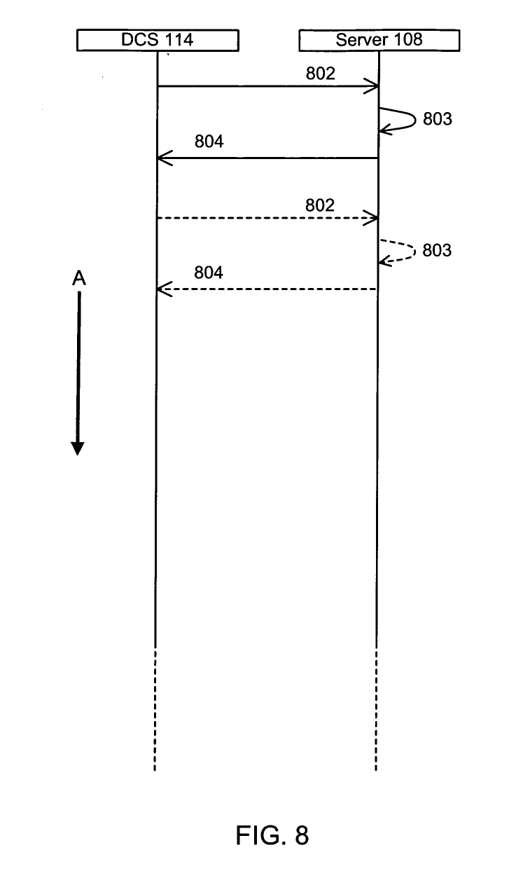

FIG. 8 is a high level interaction diagram depicting the flow of requests and responses between DCS 114 and server 108 in another embodiment describing a user at the DCS requesting location information from the server. Similar to FIGS. 6 and 7, time proceeds down the page from top to bottom as indicated by reference arrow A.

A user at DCS 114 transmits a user location request message 802 to server 108 via network 106. User location request message 802 identifies a specific user, e.g., a user of a MCS 100, the location of which the DCS user desires to know. Upon receipt of the user location request message 802, server 108 performs a query (processing loop 803 of FIG. 8) of data store 110 for the specific user identified in user location request message 802. If a matching entry is returned from data store 110, server 108 transmits a user location information message 804 to DCS 114.

In one embodiment, server 108 transmits additional location-related information to DCS 114, e.g., a map including an indicator of the specific user's most recent location, a web page formatted for displaying the most recent location of the specific user. In another embodiment, server 108 transmits a map presenting a time history and/or location history of the specific user.

Further, in another embodiment, server 108 performs a lookup via internal or external data store to refine or include additional information regarding the specific user location. For example, data store 110 may include location information for a specific user indicating the most recent location was “Starbucks at the corner of Mary and Fremont in Sunnyvale, Calif.” Server 108 supplements the location information with additional information including a geocoded location for the business and generating a graphical map displaying the particular location and information about the business, e.g., phone number, operating hours, and similar information. For example, server 108 may transmit the graphical map and location information together in a web page for display at DCS 114.

Dashed line versions of message transmission and processing 802-804 represent additional optional requests for information and provision of information between DCS 114 and server 108. For example, a user may request additional user locations. Additionally, in one embodiment, the transmitted user location request message 802 includes a request for more than one user and/or a specific group of users meeting certain criteria, e.g., users working for the same company, users in a particular geographic location, and similar groups and criteria. In each scenario, server 108 performs a query on data store 110 (processing loop 803) and returns the results to DCS 114 (user location information message 804).

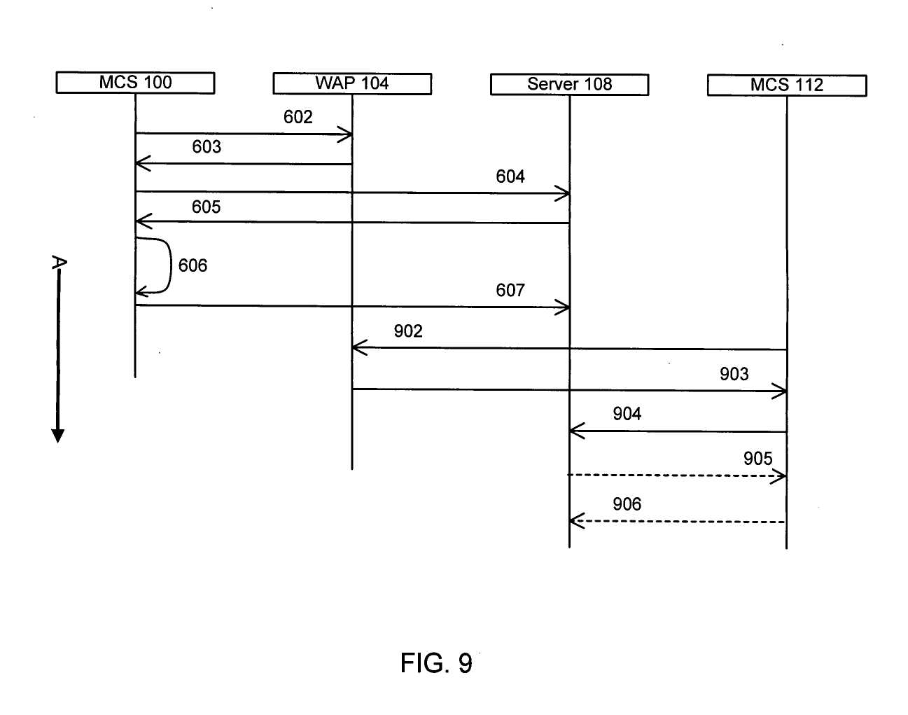

FIG. 9 is a high level interaction diagram depicting the flow of requests and responses between MCS 100, WAP 164, server 108, and a second MCS 112 according to another embodiment. Similar to FIG. 6, time proceeds down the page from top to bottom as indicated by reference arrow A.

The flow of requests and responses as depicted and described in conjunction with steps 602-607 of FIG. 6 occurs for a connection of MCS 100 to a network enabling access to server 108 as depicted in FIG. 9. In this manner, location information and connection information regarding WAP 104 and the physical location of the access point is determined and provided to server 108.

In the FIG. 9 embodiment, second MCS 112 connects to WAP 104 and transmits request message 902 requesting a connection with WAP 104 similar to MCS 100. Request message 902 is similar to request message 602 except for information specific to second MCS 112 and the later occurrence in time of the message. WAP 104 responds to request message 602 with a reply message 603 including the requested WAP connection information.

Second MCS 112, after receipt of the requested connection information, transmits the WAP connection information message 904 to server 108. Server 108 stores the received connection information in data store 110 for subsequent processing. For example, server 108 performs a lookup in data store 110 for matching connection information and retrieves the previously submitted connection information and location information from MCS 100. Based on the fact that MCS 100 already submitted location information (via message 607), server 108 determines that second MCS 112 need not provide location information corresponding to the connection information regarding WAP 104. In this manner, a second user need not be queried to provide location information in addition to that previously provided by a first user.

In an alternate embodiment, server 108 performs a lookup of the connection information received via message 904 and determines that a predetermined time has passed sufficient to require confirmation of location information previously provided by MCS 100 (via message 607) and transmits a location information query 905 (dashed line) to second MCS 112 including the previously provided user input location information from data store 110 as part of the query 905. Upon receipt of query 905, second MCS 112 queries the user for confirmation of the previously provided location information. The user manipulates second MCS 112 and confirms the previously provided location information. Second MCS 112 transmits a location information confirmation message 906 to server 108. In another embodiment, upon receipt of the confirmation from the user, second MCS 112 transmits the confirmed location information to server 108 as part of the location information confirmation message 906.

In one embodiment, if the user does not confirm the location information, second MCS 112 does not transmit a message in reply to server 108. In another embodiment, if the user does not confirm the location information, second MCS 112 transmits a negative location information confirmation message 906 indicating to server 108 that the location information is incorrect. In a further embodiment, if the user does not confirm the location information, second MCS 112 queries the user for updated location information and transmits the updated location information as part of the location information confirmation message 906. In a still further embodiment, the user enters a text description, e.g., using a text entry field, of the location and causes transmission of the location information as part of the location information confirmation message 906.

In each of the above embodiments, it is understood that authentication and/or authorization of users may be required in order to allow access to and/or storage of location information and/or connection information stored in data store 110.

It will be readily seen by one of ordinary skill in the art that the embodiments fulfill many of the advantages set forth above. After reading the foregoing specification, one of ordinary skill will be able to affect various changes, substitutions of equivalents and various other aspects of the embodiments as broadly disclosed herein. It is therefore intended that the protection granted hereon be limited only by the definition contained in the appended claims and equivalents thereof.

What is claimed is:

1. A method of calibrating a location system, comprising the steps of:
receiving connection information regarding the connection of a device to a network;
querying a user to provide input regarding the physical location of the device;
receiving user input regarding the physical location of the device connected to the network; and storing the connection information and user input.

2. The method as claimed in claim 1 wherein the connection information and user input are stored at a second device different from the device.

3. The method as claimed in claim 2, wherein the second device initiates the querying step.

4. The method as claimed in claim 1, wherein the querying step is performed based on at least one of a periodic basis and a detected network connection change.

5. The method as claimed in claim 4, wherein the querying step query requests the user to refine previously provided user input regarding the physical location.

6. The method as claimed in claim 5, wherein the querying step query requests the user to disambiguate previously provided user input.

7. The method as claimed in claim 4, wherein the querying step query includes at least one of one or more preset physical locations and previously provided user input.

8. The method as claimed in claim 1, further comprising transmitting at least one of stored connection information and stored user input to a requesting device responsive to receipt of a request from the requesting device.

9. The method as claimed in claim 1, wherein the connection information includes at least one of an identifier parameter, a network type, a time, and a connection-based parameter.

10. A computer-readable medium for calibrating a location system based on user input, comprising:
at least one sequence of instructions, wherein execution of the instructions by a processor causes the processor to perform the steps as claimed in claim 1.

11. A method of calibrating a location system using user input, the method comprising the steps of:
receiving connection information regarding connection of a device to a network;
transmitting the connection information to a second device;
querying a user of the device for user input regarding a physical location of the device;
receiving user input regarding the physical location of the device; and
transmitting the received user input to a second device.

12. The method as claimed in claim 11, wherein the querying step is performed based on at least one of a periodic basis and a detected network connection change.

13. The method as claimed in claim 11, wherein the user input includes selection of a physical location on a map.

14. A computer-readable medium for calibrating a location system based on user input, comprising:
at least one sequence of instructions, wherein execution of the instructions by a processor causes the processor to perform the steps as claimed in claim 11.

15. A location system calibrated based on user input, comprising:
a processor;
a memory connected to the processor, the memory storing instructions which, when executed by the processor, cause the processor to: transmit a request for user input to a device connected to a network, responsive to receipt of connection information from the device; and store connection information and user input received from the device.

16. The location system as claimed in claim 15, wherein the transmitted request includes at least one of one or more preset physical locations and one or more physical locations previously provided by a second user.

17. A system for providing user input to calibrate a location system, comprising:
a processor;
a memory connected to the processor, the memory storing instructions which, when executed by the processor, cause the processor to:
query a user for user input regarding the physical location of the system connected to a network, responsive to a request from a first device having received connection information from the system; and transmit user input received from the user to the first device.

18. A system for calibrating a location system based on user input, comprising:
receiving means for receiving connection information regarding the connection of a device to a network and user input regarding the physical location of the device connected to the network;
transmitting means for transmitting a request to the device to query the user for the user input; and
storing means for storing the received connection information and user input received by the receiving means.

19. The system as claimed in claim 18, wherein the receiving means further receives a request for at least one of stored connection information and user input from a requesting device, and
further comprising:
transmitting means for transmitting at least one of a stored connection information and stored user input to a requesting device responsive to the receiving means receiving the request from the requesting device.

20. The system as claimed in claim 19, wherein the request from the requesting device includes at least one of a geographic-based request, a user identity-based request, and a time-based request.
